(19) United States
(12) Patent Application Publication
(10) Pub. No.: US 2012/0203859 A1
(43) Pub. Date: Aug. 9, 2012

(54) SYSTEM AND METHOD FOR INTERACTION BETWEEN E-MAIL/WEB BROWSER AND COMMUNICATION DEVICES

(75) Inventor: Paul Krzyzanowski, Flemington, NJ (US)

(73) Assignee: OPENPEAK INC., Boca Raton, FL (US)

(21) Appl. No.: 13/021,241

(22) Filed: Feb. 4, 2011

(51) Int. Cl. G06F 15/16

(52) U.S. Cl. 709/217

(57) ABSTRACT

Systems and methods are provided for improving the interaction between e-mails/web browsers and communication devices. In such systems and methods, an action of one communication device can effect an action on another communication device. A content source identifier is presented in an email or web page being viewed on a first communication device. If the content source identifier has a specific content type descriptor associated therewith (such as a particular MIME type), then a command can be sent to a second communication device to initiate an action thereon. The command can be sent to the second communication device by the first communication device and/or by a management server communicatively linked to the first and second communication devices. In one embodiment, the first communication device can be a desktop computer or a laptop computer, and the second communication device can be a laptop computer, a tablet computer or a smart phone.

### FIELD

Embodiments relate in general to communication devices and, more particularly, to the interaction between communication devices and e-mail and/or web browsers.

### BACKGROUND

Launching applications from a Uniform Resource Locator (URL) link contained in a web browser or in an email message is well known. However, in some cases, launching an application in such a manner may detract from other tasks that the user wishes to perform on the computer. For instance, if the URL launches a video, the video content may take up the entire viewing area of the monitor. At that point, if the user wishes to watch the video, he or she must discontinue other tasks on the computer to watch the video. Alternatively, if the user wishes to multi-task, he or she must appropriately size the window of the video player so that other activities can be pursued simultaneously on the computer. Such an arrangement can be relatively time consuming, distracting, frustrating, and inefficient. Another possibility is for the user to launch the video on a separate device. However, such an approach requires the user to reopen the email message and/or to revisit the web page containing the URL link on the separate device. Again, such an approach can be relatively time consuming, cumbersome and inefficient. Thus, there is a need for a system and method that can minimize such concerns.

### SUMMARY

In one respect, embodiments are directed to a method for interaction between a first communication device and a second communication device. According to the method, a content source identifier on a first communication device is selected. The content source identifier specifies a content source or a content file, which has an associated content type descriptor. The content type descriptor can be a MIME type. The content source can be a web page, HTTP server, FTP server, or HTTP server that does not present websites. The content source identifier can be a Uniform Resource Locator, Uniform Resource Identifier, Uniform Resource Name, Internationalized Resource Identifier, or Digital Object Identifier.

The content type descriptor can be compared to a pre-identified set of one or more content type descriptors. If the content type descriptor is included in the pre-identified set of content type descriptors, then a directive containing a command can be sent to the second communication device. The directive can be sent by the first communication device. In such case, the first and second communication devices can be communicatively linked. In one embodiment, the second communication device may only permit unidirectional communication. For instance, the second communication device can be adapted to only receive directives from the first communication device.

In response to the command, an action can be initiated on the second communication device. The action can comprise accessing, executing, retrieving, and/or downloading content from the content source specified by the content source identifier. Such actions may be performed automatically, that is, without user input. In one embodiment, the action can comprise accessing a website from which application software can be downloaded.

The content source identifier can be provided to the first communication device in any suitable form and/or in any suitable manner. For instance, the content source identifier can be provided in an email message, an instant message, a web page or a content source. Alternatively, the content source identifier can be provided as a file attached to a message.

In one embodiment, the first and/or second communication devices can be communicatively linked to a management server. In such case, the sending step can include the first communication device sending a request to the management server and, responsive to the request, the management server sends the directive containing a command to the second communication device or obtains content for delivery to the second communication device.

In another respect, embodiments are directed to a system for improved interaction between communication devices. The system includes a first communication device and a second communication device. The first and/or second communication devices can be a portable communication device. The first and second communication devices can be communicatively linked. In some instances, the second communication device can be adapted to only receive directives from the first communication device; that is, the second communication device does not transmit directives to the first communication device.

The first communication device is configured to receive a user input selecting a content source identifier that specifies a content source or a content file, which have an associated content type descriptor. The content type descriptor can be a MIME type. The content source can be a web page, HTTP server, FTP server, or HTTP server that does not present websites. The content source identifier can be a Uniform Resource Locator, Uniform Resource Identifier, Uniform Resource Name, Internationalized Resource Identifier, Digital Object Identifier or a content file attached to a message.

The first communication device is further configured to compare the content type descriptor to a pre-identified set of one or more content type descriptors. The first communication device is also configured to send a directive containing a command to the second communication device if the content type descriptor is included in the pre-identified set of content type descriptors. The second communication device is configured to initiate an action specified by the command received from the first communication device.

The system can further include a management server. The first and/or second communication devices can be communicatively linked to the management server.

In still another respect, embodiments are directed to a communication device. The communication device includes a processor and a transceiver. The transceiver can be configured to receive a user input selecting a content source identifier. The content source identifier specifies a content source or a content file, which have an associated content type descriptor. The processor is operable to compare the content type descriptor to a pre-identified set of one or more content type descriptors. The processor is further operable to send a directive containing a command to a second communication device if the content type descriptor is included in the pre-identified set of content type descriptors. In such case, the second communication device can initiate an action specified by the command received from the first communication device.

### BRIEF DESCRIPTION OF THE DRAWINGS

FIG. 1 is a diagrammatic view of a system for providing improved interaction between e-mail/web browsers and communication devices.

FIG. 2 is a method for providing improved interaction between e-mail/web browsers and communication devices, wherein an action on a first communication device effects an action on a second communication device.

FIG. 3 is a diagrammatic view of a system for providing improved interaction between e-mail/web browsers and communication devices, wherein the system includes a management server.

FIG. 4 is a method for providing improved interaction between e-mail/web browsers and communication devices, wherein an action on a first communication device effects an action on a second communication device by way of the management server.

FIG. 5 is a method for providing improved interaction between e-mail/web browsers and communication devices, wherein an action on a second communication device effects an action on a first communication device.

### DETAILED DESCRIPTION

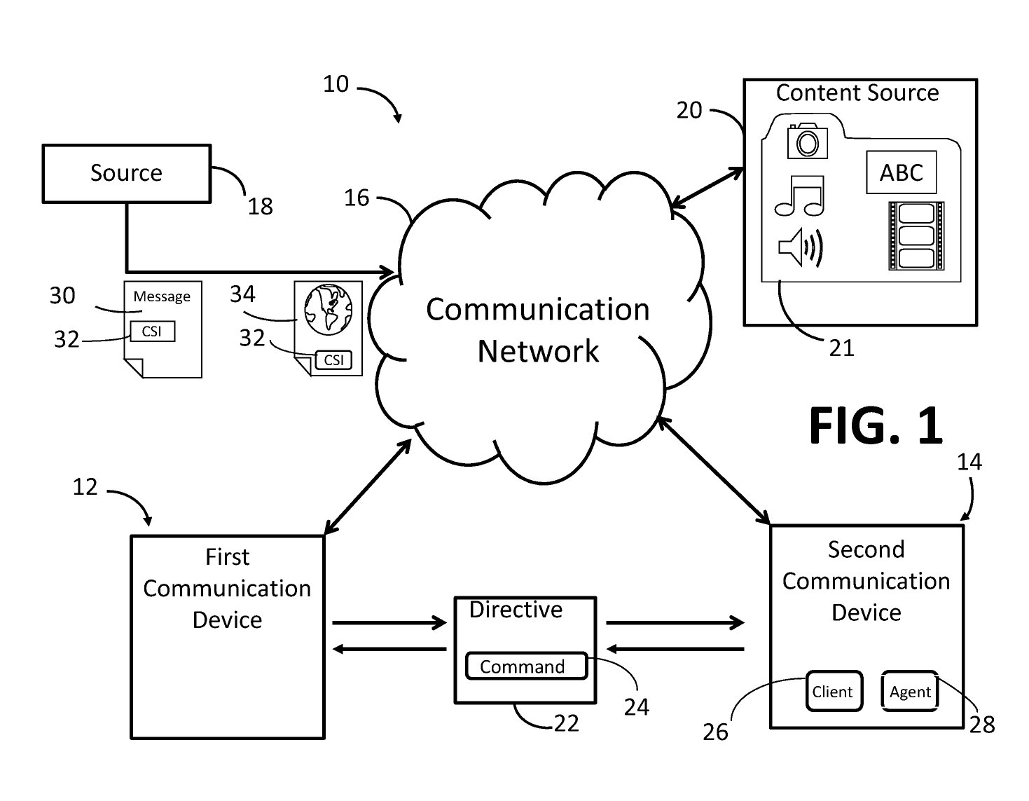

Arrangements described herein relate to a system and method for improving the interaction between e-mails/web browsers and communication devices. In such systems and methods, an action of one communication device can effect an action on another communication device. Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of embodiments and aspects herein. Arrangements are shown in FIGS. 1-5, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Referring to FIG. 1, an exemplary system 10 for providing improved interaction between e-mail/web browser and a communication device is shown. The system 10 can include a first communication device 12, a second communication device 14, and a communication network 16. The communication network 16 can comprise the Internet, a wide area network (WAN), a local area network (LAN), wireless local area network (WLAN) transceiver, a personal area network (PAN), a wireless communication network, and/or the like. The communication network 16 can include one or more components designed to transmit and/or receive information from one source to another. The communication network 16 can include wired communication links and/or wireless communication links.

The first and second communication devices 12, 14 can be any suitable type of communication device. The first communication device 12 can be, for example, a desktop computer or a laptop computer. The first communication device 12 can also be a cellular telephone, a smart phone, a personal digital assistant (“PDA”), a tablet computer, a digital reader, a handheld device having wired or wireless connection capability, a computer, a portable communication device, a portable computing device, an entertainment device (e.g., a music or video device, TV set-top box, smart TV, connected TV, or a satellite radio), a global positioning system device, a digital audio player (e.g., MP3 player), an e-book reader, a camera or a game console. In at least some instances, the first communication device 12 may be a relatively large device that is not readily carried by a user, such as a desktop computer.

The second communication device 14 can be any of the devices listed above in connection with the first communication device 12. In at least some instances, the second communication device 14 can be a portable communication device, that is, a relatively small device that can be readily carried by a user. Some examples of a portable communication device include a smart phone, a tablet computer or a laptop computer. The first and second communication devices 12, 14 can be different types of devices. However, in some instances, the first and second communication devices 12, 14 can be the same type of device. In one embodiment, the first communication device 12 can be a desktop computer or a laptop computer, and the second communication device 14 can be a portable communication device.

It will be understood that the first and second communication devices 12, 14 may be able to communicate bidirectionally or unidirectionally. In some embodiments, the first or second communication device 12, 14 can be configured to allow bidirectional communication, and the other communication device may only allow unidirectional communication therebetween. For example, the first communication device 12 may be a tablet computer with a web browser, and the second communication device 14 may be a set-top box operatively connected to a television. In such case, the set top box may be configured to receive communications from the tablet computer but not transmit communications to the tablet computer. Thus, in some cases, the first or second communication device 12, 14 may not be connected to communication network 16. In such case, one of the communication devices 12, 14 may be communicatively linked solely to receive content from the other communication device.

The first and second communication devices 12, 14 can include a number of components to support their functionality. For instance, each of the first and second communication devices 12, 14 can include a processor, memory, a computer-readable storage medium, a network adapter, a user input interface (e.g., a display, touch screen display, buttons, joystick, trackpad, track ball, mouse, and/or microphone), an output system (e.g., a display, touch screen, earphone and/or speaker), a component interface, a power supply and/or other components known to those skilled in the art. These components can be operatively connected on each of the communication devices 12, 14 in any suitable manner.

The computer-readable storage medium can be communicatively linked to the processor. The computer-readable storage medium can include one or more storage devices, each of which may include, but is not limited to, a magnetic storage medium, an electronic storage medium, an optical storage medium, a magneto-optical storage medium, and/or any other storage medium suitable for storing digital information. In one arrangement, the computer-readable storage medium can be integrated into the processor, though this need not be the case. The various software applications described herein can be stored on the computer-readable storage medium or otherwise made accessible to the processor. Such application software can be executed by the processor to implement the methods and processes described herein that are performed by the system 10.

The first and second communication devices 12, 14 can be configured to allow actions on one of the communication devices 12, 14 to effect actions on the other one of the communication devices 12, 14. To that end, the first and second communication devices 12, 14 can be communicatively linked. The term “communicatively linked” can include direct or indirect connections through a communication channel or pathway or another component or system.

In one embodiment, the first and second communication devices 12, 14 can be directly linked. Alternatively, the first and second communication devices 12, 14 can be communicatively linked by a network, which may be a wired or wireless network. The network may be dedicated specifically to the first and second communication devices 12, 14. Alternatively, the network can be communicatively linked to other devices, such as the communication network 16. In either arrangement, the links between the first and second communication devices 12, 14 can be in a peer-to-peer fashion or they can be managed in a centralized manner.

The first and second communication devices 12, 14 can be communicatively linked by any suitable type of direct or network connection. For instance, the connections can include any of those described above, as well as those in accordance with Bluetooth, ZigBee, Wi-Fi, WiMax, 3G, 4G, WirelessHART, MiWi, the IEEE 802 set of wireless local area network communications (for example, IEEE 802.11n), IEEE 802.15.4 and 802.16 (WiMAX), Near Field Communication (NFC), EUTRAN, UMB, WPA, WPA2, GSM, TDMA, CDMA, WCDMA, OFDM, or LTE. Still, embodiments are not limited in this regard and the system can be configured to communicate RF signals in accordance with any other suitable communication standard, protocol, and/or architecture, or a suitable combination of such standards, protocols, and/or architectures. Alternatively or in addition, the first and second communication devices 12, 14 can be communicatively linked by a wired connection, such as by Ethernet, Universal Serial Bus (USB), IEEE 1394 (FireWire), External Serial ATA, etc.

The first and second communication devices 12, 14 can be equipped with receivers and/or transceivers that are configured for the any of the various types of links described above. The transceiver can be configured to communicate data via any of the above-mentioned communications standards, protocols, and/or architectures. Further, the transceiver also can be configured to communicate over a wireless communication link using any of various communications protocols, for example, TCP/IP. In this regard, the transceiver may be embodied as a wired or wireless network adapter.

Further, the first communication device 12 and/or the second communication device 14 can include software to support communicative linking therebetween. For instance, the first communication device 12 and/or the second communication device 14 can include application software that can enable at least in part communication therebetween. Such application software can be configured with a device identifier of the other one of the first and/or second communication devices 12, 14 and/or its connectivity. For instance, the device identifier can be the Internet Protocol (IP) address, Media Access Control (MAC) address, the domain name and/or other suitable identifier of the other of the first and/or second communication devices 12, 14. Alternatively or in addition, the device identifier can include the connectivity of the other of the first and/or second communication devices 12, 14 (IP-based, USB-based, Bluetooth, or other connectivity). Such device identifier can be stored in any suitable source and in any suitable manner, including, for example, in a configuration file.

The first communication device 12 and/or the second communication device 14 can be configured to listen for, authenticate and/or process commands from the other one of the first communication device 12 and/or second communication device 14. Such functionality can be implemented with hardware, software and combinations of hardware and software. In one embodiment, the first and/or second communication devices 12, 14 can include a client 26 and an agent 28 instantiated thereon. For simplicity, only the second communication device 14 is shown as being equipped with a client 26 and an agent 28 in FIG. 1, but it will be understood that, alternatively or in addition, the first communication device 12 can also include a client and agent instantiated thereon.

The client 26 and agent 28 can be implemented as computer-readable code that, when executed by the processor, implement at least some of the various processes described herein. The term “client” means client-side software instantiated on a communication device 14 that establishes a communication link with another communication device and, among other things, listens for and/or receives directives from the other communication device. The term “agent” means client-side software that is instantiated on a communication device that implements the commands received from another communication device. The agent 28 can be implemented on a communication device as a component of the client 26 or as a separate component with which the client 26 communicates.

The system 10 can include a source 18 of a content source identifier. The source 18 can be any source of a message 30, such as an email message or an instant message, or a web page 34. As an example, the source 18 can be a server of some other suitable computing device that can present data in any suitable form to the first and second communication devices 12, 14. The first communication device 12 can be communicatively coupled to the source 18 in any suitable manner, such as by the communication network 16. Thus, a message 30 or web page 34 from the source 18 can be sent to and/or accessed by the first communication device 12 and/or the second communication device 14. In some instances, the message 30 and/or web page 34 can include a content source identifier 32, such as a Uniform Resource Locator (URL), Uniform Resource Identifier (URI), Uniform Resource Name (URN), Internationalized Resource Identifier (IRI), or Digital Object Identifier (DOI). The content source identifier 32 can refer to the primary content, such as the entire message, or to one or more identifiers embedded within the content to refer to links or embedded content, such as MIME attachments in an email message. The term “content source identifier” is defined as an element that facilitates the transfer of data from one unit to another by at least directing one of the units to the other unit.

The content source identifier 32 can be associated with a content source 20 that includes one or more content files 21. The term “content file” is defined as is a set or collection of information or data that can be in the form of text programs, graphics, video, audio, animation, still images, interactivity data, and/or any related instructions for such content. Each content file 21 can have an associated content type descriptor. A “content type descriptor” is defined as any description in any form of the one or more types of content associated with a content file. In one embodiment, the content type descriptor can be the Multipurpose Internet Mail Extensions (MIME) type of the file 21. In some instances, the content type descriptor can be associated with the content and sent by the server (e.g., as a MIME type). Alternatively, the content type descriptor can be inferred by the markup or metadata within the envelope or enclosing content (e.g., explicit HTML markup, such as an IMG tag for an image; or inference from the file name, such one of several specific file extensions).

The term “content source” is defined as a server or other device that can store one or more forms of content and/or provide one or more forms of content for delivery to or access by a user of a communication device. In one particular example, the content source 20 can be the target of the content source identifier 32 that is embedded within the message 30 or web page 34. Examples of content include text, audio, video, animation, still images and/or interactivity data. The content source 20 can be a web page 34, web server (HTTP server), File Transfer Protocol (FTP) server (not shown), or a web server (HTTP server) that does not necessarily present websites. In addition to HTTP and FTP, one may use other protocols such as file sharing (SMB, NFS, AFP, etc.) or distributed authoring (WebDAV), as well as others and custom content serving protocols. In one embodiment, the content source 20 can be a file attached to an email. The first and/or second communication device 12, 14 can be communicatively connected to the content source 20 such that content and/or content files 21 can be received from and/or accessed from the content source 20 and/or sent from the content source 20 to the first and/or second communication device 12, 14.

The first and/or second communication devices 12, 14 can access the content source 20 or other content sources by way of the communication network 16 and by using a software application that interfaces with the content source 20, such as a web browser. A “web browser” means a software application for retrieving, presenting, and/or traversing information resources on the Internet. The web browser or other application software can be stored and/or executed on the first and/or second communication device 12, 14.

The content source 20 may contain a content source identifier 32. When selected, the content source identifier 32 can direct a user to another content source, which can include one or more content files 21. Each content file 21 can have an associated content type descriptor. The content type descriptor can be any suitable descriptor of the content associated with the content file 21, including, for example, the MIME type of the file 21. The software application that interfaces with a content source, such as web browser, can be configured to process content type descriptors. Alternatively or in addition, one or more components of the first and/or second communication devices 12, 14 can be configured to process the content type descriptor. The software application that interfaces with a content source, such as a web browser, can be configured to map an association between a file type (name extension) and content type descriptor.

Regardless of whether the content source identifier 32 is provided in an email message 30 or instant message, or on a website 34, the content source identifier 32 can be selected by a user. The term “selected” is defined as clicking, engaging or otherwise using a content source identifier so that the content source or content file specified by the content source identifier is accessed, initiated and/or executed.

The system can include an application software program to facilitate communication between the first and second communication devices 12, 14 when a content source 20 or content file 21 having a certain content type descriptor is being accessed, initiated and/or executed. The application software program can be installed on the first and/or second communication device 12, 14. The application software program can be preinstalled, installed at runtime or installed at any other suitable time. Any suitable application software program can be used. For instance, the application software program can be a web browser-based Java or Active-X application. Alternatively, the application software program can be a registered standalone application that is invoked by the web browser on the basis of the protocol or content type descriptor specified in the content source identifier 32.

As will be described in greater detail later, the first and/or second communication device 12, 14 can be configured to evaluate a characteristic of the content file 21. In some instances, such evaluation can be made at least in part by a processor of the first and/or second communication device 12, 14. In one instance, the first and/or second communication device 12, 14 can be configured to evaluate a content type descriptor associated with the content file 21, such as by evaluating the MIME type of the content file 21. To that end, the first and/or second communication device 12, 14 can be configured to include a pre-identified set of one or more content type descriptors. If the evaluated content type descriptor is one of the pre-identified content type descriptors, then, as will be described in greater detail below, the system can be configured to initiate an action of the other one of the first and/second communication device 12, 14. If the evaluated content type descriptor is not one of the pre-identified content type descriptors, then the system can be configured to initiate an action on the device from which the content source 20 or the content file 21 is being accessed.

When a content source identifier 32 is selected on the first communication device 12, the application software program can be configured to take certain actions if the content source identifier 32 is directed to a content source 20 having a content file 21 with a pre-identified content type descriptor. In certain cases, the content source 20 may be present on the first communication device 12 itself. An example is an email message 30 with a file attachment. The file, such as a video file, can have an associated content type descriptor. For a given content type descriptor, the application software program can be configured to send a directive 22 from the first communication device 12 to the second communication device 14. The term “directive” means one or more commands, programs, requests, content or instructions for initiating an action on a communication device. The directive can be sent in any suitable form, including as a message communicated to the respective receiving communication device. In such case, the message can include at least one command to be executed by the receiving communication device. In one embodiment, the directive 22 can include a command 24 that can cause the second communication device 14 to select the content source identifier selected on the first communication device 12.

The first and/or second communication device 12, 14 can include a detection system that can listen for signals from the other one of the communication devices 12, 14. The detection system can comprise hardware, software, or combinations thereof. The detection system can be provided as part of the client 26. The detection system can include a receiver or a transceiver. The first and/or second communication device 12, 14 can include application software to support a variety of computer telephony integration (CTI) features that include click-to-dial, click-to-talk, click-to-chat, click-to-text, user interface replication on the other communication device, backup/sync, etc.

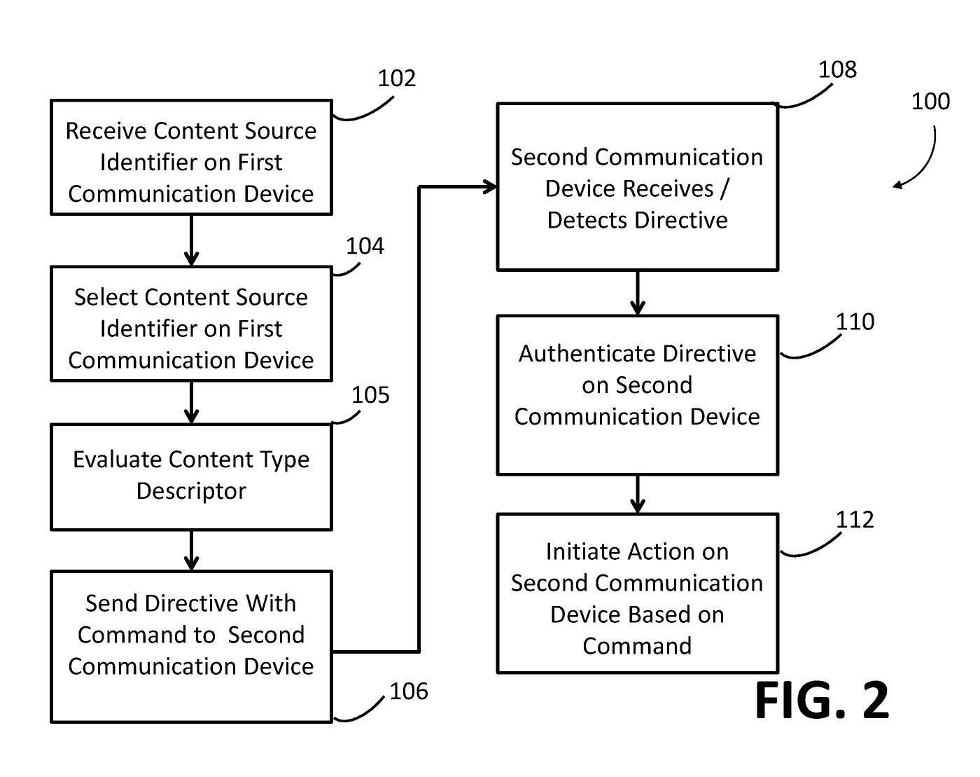

Now that various possible components of the system 10 have been described, one manner of the operation of the system will now be described in connection with FIG. 2. FIG. 2 shows an exemplary method 100 for improving the interaction between e-mails/web browsers and communication devices. The method 100 illustrated in FIG. 2 may be applicable to the embodiments described above in relation to FIG. 1, but it is understood that the method 100 can be carried out with other suitable systems and arrangements. Moreover, the method 100 may include other steps that are not shown here, and in fact, the method 100 is not limited to including every step shown in FIG. 2. The steps that are illustrated here as part of the method 100 are not limited to this particular chronological order, either.

Various possible steps of method 100 will now be described. At step 102, a user can receive a content source identifier 32, such as a URL link, on the first communication device 12. Again, the content source identifier 32 can be included in an email message 30, instant message or on a content source 20, such as a web page 34 or FTP server, being accessed by the first communication device 12. At step 104, the user can select the content source identifier 32.

The content source identifier 32 can be for a file with a specific content type descriptor, such as a particular MIME type. When the browser downloads or accesses that file, the content type descriptor of the file can be evaluated at step 105. If the content type descriptor is a predetermined content type descriptor, an application software program on the first communication device 12 can be launched. At step 106, by way of the application software program, the first communication device 12 can communicate with the second communication device 14 and send a directive 22 containing at least one command 24 to the second communication device 14. It should be noted that there may be instances in which the content type descriptor is not one of the predetermined content type descriptors. In such case, the default can be for the system 10 to present the content of the content source specified by the content source identifier on the communication device from which the content source identifier was selected. In this example, the content source specified by the content source identifier would be accessed, retrieved, and/or downloaded for initiation, execution, or display on the first communication device 12. However, any suitable defaults and protocols can be implemented.

At step 108, the second communication device 14 can receive and/or detect the directive 22. In some instances, the second communication device 14 can authenticate the directive 22, as is shown in step 110. Any suitable form of authentication can be used.

At step 112, the directive 22 can be processed to initiate an action on the second communication device 14. Any suitable action can be initiated at step 112. For instance, content can be accessed, retrieved, and/or downloaded for initiation, execution, or display on the second communication device 14. For instance, the content from the content source 20 specified by the content source identifier can be accessed, retrieved, and/or downloaded for initiation, execution, or display on the second communication device 14. In one embodiment, a video can be downloaded onto the second communication device 14, such as from content source 20. Alternatively or in addition, the second communication device 14 can download and install an application software program thereon.

In one embodiment, the content source identifier 32 can be provided in an email message 30, and the content source identifier 32 can be a URL link or other type of link directed to a videoconference. By selecting the content source identifier 32 on the first communication device 12, the first communication device 12 can send a directive 22 to the second communication device 14 such that the videoconference is initiated on the second communication device 14. In this way, the first communication device 12 can remain free for other uses while the videoconference is presented on the second communication device 14.

In another example, a user could access a content source, such as a website 34, on the first communication device 12. The website 34 can present one or more content source identifiers 32 to videos, such as training videos. Selecting a content source identifier 32 causes the first communication device 12 to send a directive 22 to the second communication device 14 with a command 24 for the second communication device 14 to download or access the selected training video. The training video may be displayed on the second communication device 14. As a result, the first communication device 12 is unencumbered for other purposes.

In yet another example, a user can use a web browser to search for applications on the communication network 16, such as the Internet, using the first communication device 12. A content source identifier 32 can be presented to a user on a website 34. When the user selects the content source identifier 32, the first communication device 12 can send a directive 22 to the second communication device 14 with a command 24 to access an online application software shop, such as via communication network 16, to allow a user to download the application software. Alternatively, the second communication device 14 can automatically access, download and/or install an application software program without further user input.

In another embodiment, the content source 20 may be present on the first communication device 12 itself. For instance, an email message 31 can have a content file 21 attached thereto. As an example, the content file 21 can be for a video or other media content. In such case, the content source identifier can be the file name itself or an icon or other graphical representation of the file that can be selected by the user. The content file 21 can have an associated content type descriptor. When the user selects the content file 21 for execution, the content type descriptor can be processed by the first device. If the content type descriptor is a pre-identified content type descriptor, then the first communication device 12 can send the content file 21 with the directive 22 to the second communication device 14 for execution thereon. Alternatively, the first communication device 12 may extract the content file 21 and make it available for streaming by the second communication device 14.

Alternatively or in addition to the above, selection of a content source identifier 32 on the first communication device 12 can send a directive 22 to the second communication device 14 with a command 24 to automatically dial a telephone number on the second communication device 14 or to provide a prompt on the second communication device 14 with a phone number for dialing upon receiving a user input, such as by pressing a graphical button or a physical button on the device.

Again, the above examples of various actions that can be initiated on the second communication device 14 based on an action selected on the first communication device 12 are merely provided to facilitate the discussion. Thus, it will be understood that embodiments are not limited to the specific examples herein. It will be appreciated that such systems and methods can provide numerous benefits. For instance, systems and methods herein can avoid that time consuming and inefficient steps that would have to be performed if a user wishes to multi-task on the same computer. Further, the systems and methods herein can allow the user to find or access content using one user interface but consume the content on another device that may present more a beneficial or convenient interface. Moreover, the systems and methods herein can help to avoid requiring the user to redo steps on a second communication device once content is found on a first communication device.

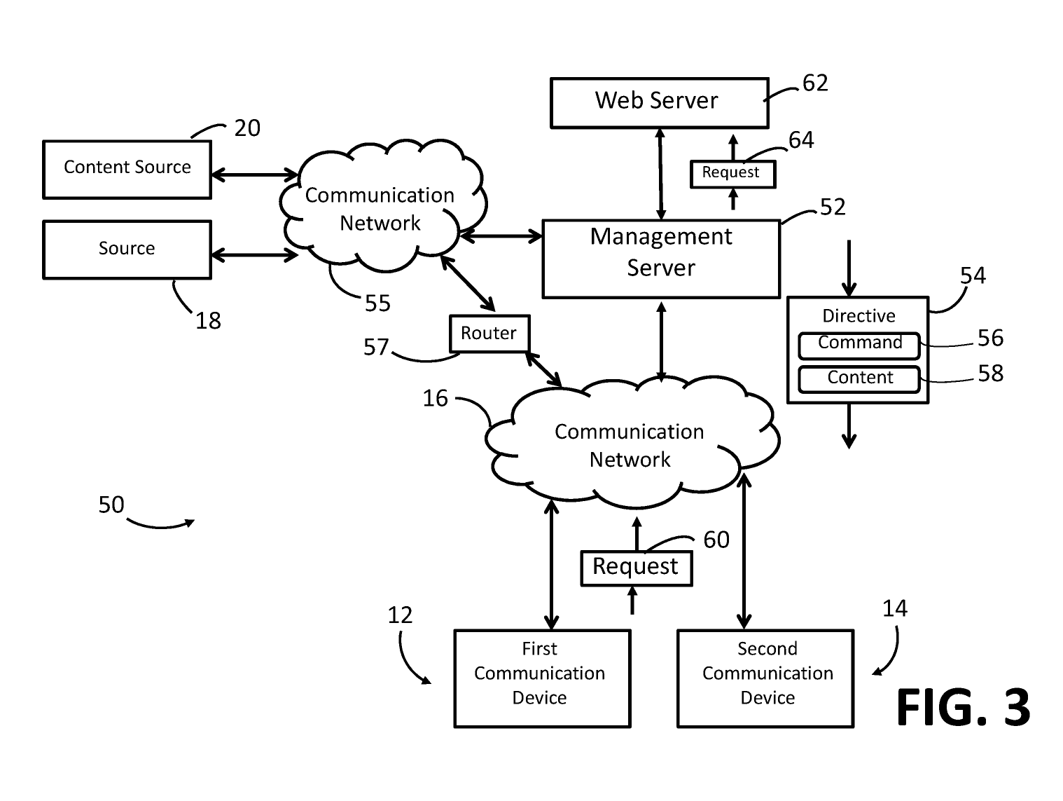

Referring to FIG. 3, another system 50 is shown that includes a management server 52. The management server 52 can be communicatively linked to manage one or more communication devices. For instance, the first and second communication devices 12, 14 can be communicatively linked to and managed by the management server 52. The first and second communication devices 12, 14 can be communicatively linked to the management server 52 in any suitable manner, such as by the communication network 16, some other network including any of those mentioned herein or by other suitable means.

The management server 52 can be a trusted entity that is capable of sending directives 54 and/or content 58 to one or more communication devices managed thereby, including the first and/or second communication devices 12, 14. These directives 54 include, but are not limited to, directives such as a notice of new firmware, a request to download firmware, a request to reboot the system, or a request to install an application software program.

The system 50 can have some similarities to the system 10 described above. Accordingly, the above description of the first communication device 12, the second communication device 14, the communication network 16, the source 18, the content source 20 and other components and features of the system 10 can apply equally to the system 50. However, in system 50, there may not be any direct communication between the first and second communication devices 12, 14. Instead, the first and/or second communication device 12, 14 can use the management server 52 as a proxy server.

In such case, the first communication device 12 and/or the second communication device 14 can send a request 60 for some service (such as a file, connection, web page, or other resource, available from a different server) to the management server 52. The management server 52 can evaluate the request according to its filtering rules. The management server 52 may filter and possibly reject certain requests based on policy or other rules. If the request is validated by the filter, the management server 52 can provide the resource by connecting to the relevant server (such as content source 20) and requesting the service on behalf of the first and/or second communication devices 12, 14, as the clients of the management server 52.

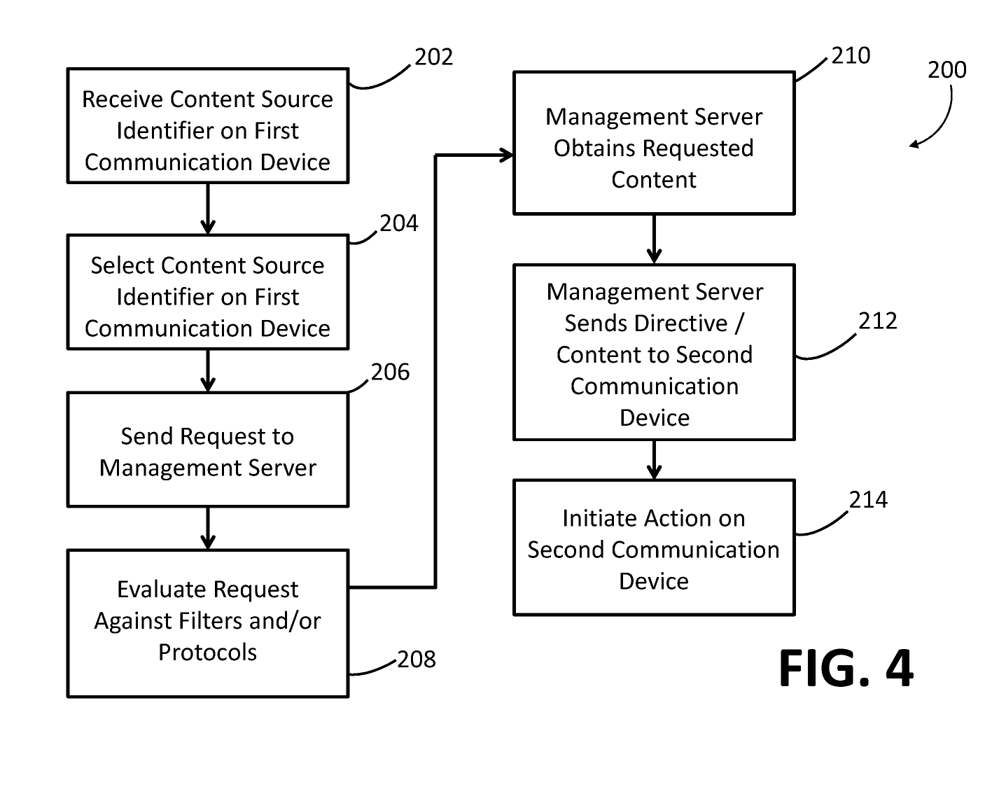

One manner of the operation of the system 50 will now be described in connection with FIG. 4. With these examples in mind, various possible steps of method 200 will now be described. The method 200 illustrated in FIG. 4 may be applicable to the embodiments described above in relation to FIG. 3, but it is understood that the method 200 can be carried out with other suitable systems and arrangements. Moreover, the method 200 may include other steps that are not shown here, and in fact, the method 200 is not limited to including every step shown in FIG. 4. The steps that are illustrated here as part of the method 200 are not limited to this particular chronological order, either.

Referring to FIG. 4, an exemplary method 200 for improving the interaction between e-mails/web browsers and communication devices is shown. At step 202, a user can receive a content source identifier 32 on a first communication device 12, which can be, for example, a desktop computer or a laptop computer. Again, the content source identifier 32 can be included in an email message 30, instant message or it can be included on a website 34 being accessed by a user of the first communication device 12. In any event, at step 204, the user can select the content source identifier 32.

As a result, at step 206, the first communication device 12 can send a request 60 to the management server 52. The management server 52 can evaluate the request 60 at step 208 against any protocols and/or filters. If the request 60 does not pass step 208, then the request 60 can be disregarded such that no action is taken. The user may be notified in such case. If the management server 52 responds with a failure (i.e., it could not communicate with the second communication device 14 or there was a policy violation because the second communication device 14 is on a different network), then the system can default to launching the content on the first communication device 12.

On the other hand, if the request 60 is validated, then the management server 52 can obtain the requested service or content provided in the content source identifier 32, at step 210. The content source identifier 32 can be for a content source having a content file with a specific associated content type descriptor, such as MIME type. The content type descriptor of the file can be evaluated. If the content type descriptor is a predetermined content type descriptor, the management server 52 can be configured to send content from the content source specified by the content source identifier to the second communication device 14 at step 212. The content can be presented on the second communication device 14 at step 214.

Alternatively, at step 212, the management server 52 can communicate with the second communication device 14 and send a directive 54 containing at least one command 56 to the second communication device 14. At step 214, the directive 54 can be processed to initiate an action on the second communication device 14. Any suitable action can be initiated at step 214. For instance, content can be accessed, retrieved, and/or downloaded for initiation, execution, or display on the second communication device 14.

Still alternatively, the content, message and/or directive may not be processed by the management server 52. Instead, the first communication device 12 can send a directive 22 with a command 24 to the second communication device 14 (not shown in FIG. 3), either directly or indirectly as described above in connection with the embodiments shown in FIGS. 1 and 2. Directive 22 is used herein to refer to directives sent by one of the communication devices 12, 14, and directive 54 is used herein to refer to directives sent by the management server 54. As is shown in FIG. 3, the first and/or second communication devices 12, 14 can access a communication network 55 without passing through the management server 52. In such case, the communication network 16 can be communicatively linked to another communication network, such as communication network 55, in any suitable manner, including by a router 57 or a gateway or other suitable device. In such case, the management server 52, however, may (a) originate messages, (b) originate content, and/or (c) send configuration changes concerning the handling of content and its disposition to devices managed thereby.

It should be noted that there may be instances in which the content type descriptor, such as the MIME type or other descriptor, is not one of the pre-identified set of one or more content type descriptors. In such case, the default can be for the system 50 to present the content from the content source associated with the content source identifier on the communication device from which the content source identifier was selected.

The use of a system having a management server can have numerous benefits. For instance, the user does not have to keep track of the identity/address of the associated communication devices, as such actions can be done by the management server. Further, the management server can have the ability to filter and possibly reject certain requests based on policy. Moreover, such an arrangement can ensure that the first and/or second communication devices communicate only with a single trusted entity.

Alternatively, the content source identifier 32 provided in the email message 30, instant message, or web page 34 can be structured to point to a web server 62 that is hosted by the management server 52, as is shown in FIG. 3. In such case, selecting the content source identifier 32 can effectively cause a request 64 to be made by the management server 52. As before, the content source identifier 32 can contain all the parameters of the request, allowing the server to send the command to the second communication device 14.

In embodiments in which a management server is provided, the management server can be configured to recognize the association of the communication devices to users. Such recognition can be set at any suitable time, such as upon initialization. However, in some instances, it may be necessary or desirable to establish the identity of an end user. User identity can be established in any suitable manner. For instance, user identity can be established by a stored cookie. A cookie being set in the browser can help simplify future requests. Alternatively, user identity can be established by the source IP address; that is, the IP address of the first communication device 12, the second communication device 14 and/or the management server 52. Still alternatively, user identity can be established by a web form/pop-up interface that can request suitable user identification.

While examples herein have been described in connection with instances in which an action on the first communication device 12 initiates an action of the second communication device 14, it should be noted that there may be some instances in which an opposite arrangement is provided. That is, an action on the second communication device 14 can result in a directive 22 being sent to the first communication device 12 so that an action is initiated thereon. In such case, the first communication device can be configured to listen for, authenticate and process directives 22 and commands 24. Such an arrangement can be implemented with hardware, software and combinations of hardware and software.

There may be various instances in which such an arrangement is desirable. For instance, a user may prefer to watch videos on his or her first communication device 12 instead of a second communication device 14, if both devices are connected to the same network. Thus, when the user clicks on a content source identifier to play a video or other content, the second communication device 14, in processing the content type descriptor of the message, will not launch a video player in the second communication device 14. Instead, the second communication device 14 will send a request 60 to the management server 52 and/or a directive 22 to the first communication device 12. Another example in which such an arrangement may be desirable can be when one of the communication devices, such as a smart phone, does not have the necessary components (or has inoperative components) for supporting video calls, but the user needs to participate in a videoconference. In such case, the user can use the smart phone to have the videoconference initiated on a second communication device, such as a desktop or laptop computer, so that he or she can participate.

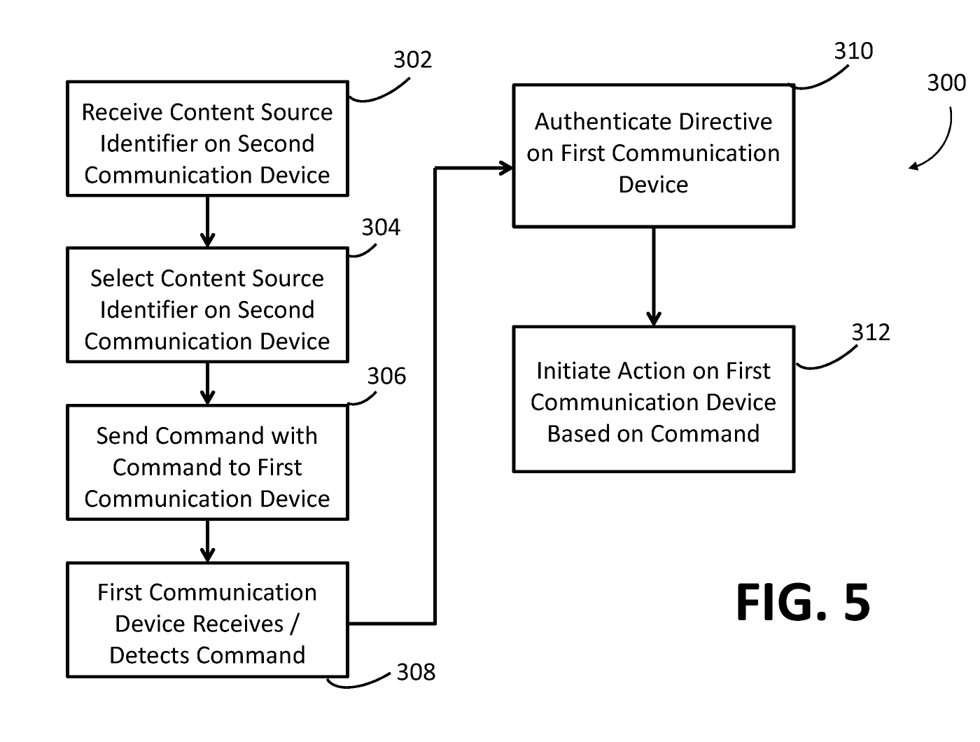

One example of such an arrangement in which an action on the second communication device 14 effects an action of the first communication device 12 is shown in FIG. 5. The method 300 illustrated in FIG. 5 may be applicable to the embodiments described above in relation to FIG. 1, but it is understood that the method 300 can be carried out with other suitable systems and arrangements, including the system 50 shown in FIG. 3. Moreover, the method 300 may include other steps that are not shown here, and in fact, the method 300 is not limited to including every step shown in FIG. 2. The steps that are illustrated here as part of the method 300 are not limited to this particular chronological order, either.

In this instance, the first communication device 12 can be a desktop computer or a laptop computer, and the second communication device 14 can be a portable communication device, such as a smart phone or tablet computer. At step 302, a user can receive a content source identifier 32 on the second communication device 14. The content source identifier 32 may be included in an email message 30, instant message or on a web page 34 being accessed by the second communication device 14. At step 304, the user can select the content source identifier 32.

The content source identifier 32 can specify a content source 20 having a content file 21 with a specific content type descriptor, such as a MIME type. When the web browser downloads or accesses the content file 21, the content type descriptor of the file can be identified and/or processed. If the content type descriptor is included in a pre-identified set of one or more content type descriptors, an application software program on the second communication device 14 can be launched. At step 306, by way of the application software program, the second communication device 14 can communicate with the first communication device 12 and send a directive 22 containing at least one command 24 to the second communication device 14.

It should be noted that there may be instances in which the MIME type or other identifier is not one of the predetermined MIME types or identifiers. In such case, the default can be for the system 10 to present the content of the content source identifier on the communication device from which the content source identifier was selected. In this example, the content of the content source identifier would be presented on the second communication device 14.

At step 308, the first communication device 12 can receive and/or detect the directive 22. In some instances, the first communication device 12 can authenticate the directive 22, as is shown in step 310. Any suitable form of authentication can be used.

At step 312, the directive 22 and/or command 24 can be processed to initiate an action on the second communication device 14. Any suitable action can be initiated at step 312. For instance, content can be accessed, retrieved, and/or downloaded for initiation, execution, or display on the first communication device 12.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

Embodiments and aspects herein can be realized in hardware, software, or a combination of hardware and software. Embodiments and aspects herein can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with computer-usable program code that, when being loaded and executed, controls the processing system such that it carries out the methods described herein. Embodiments and aspects herein also can be embedded in a computer-readable storage, such as a computer program product or other data programs storage device, readable by a machine, tangibly embodying a program of instructions executable by the machine to perform methods and processes described herein. Embodiments and aspects herein also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

Aspects can be embodied in other forms without departing from the spirit or essential attributes thereof. Accordingly, reference should be made to the following claims, rather than to the foregoing specification, as indicating the scope of the invention.

What is claimed is:

1. A method for interaction between a first communication device and a second communication device comprising:
selecting a content source identifier on a first communication device, the content source identifier specifying a content source or a content file with an associated content type descriptor;
comparing the content type descriptor to a pre-identified set of one or more content type descriptors;
if the content type descriptor is included in the pre-identified set of content type descriptors, sending a directive containing a command to the second communication device; and
initiating an action on the second communication device responsive to the command.

2. The method of claim 1, further including providing the content source identifier to the first communication device in an email message, an instant message, a web page or a content source.

3. The method of claim 1, wherein initiating the action comprises at least one of accessing, executing, retrieving, or downloading content from the content source specified by the content source identifier.

4. The method of claim 3, wherein the accessing, executing, retrieving, or downloading is performed automatically.

5. The method of claim 1, wherein initiating the action comprises accessing a website from which application software can be downloaded.

6. The method of claim 1, wherein sending the directive is performed by the first communication device, and wherein the first and second communication devices are communicatively linked.

7. The method of claim 1, wherein the second communication device is adapted to only receive directives from the first communication device.

8. The method of claim 1, wherein the content type descriptor is a MIME type.

9. The method of claim 1, wherein the content source is a web page, HTTP server, FTP server, or HTTP server that does not present websites.

10. The method of claim 1, wherein the content source identifier is a Uniform Resource Locator, Uniform Resource Identifier, Uniform Resource Name, Internationalized Resource Identifier, or Digital Object Identifier.

11. The method of claim 1, wherein the content source identifier is a file attached to a message.

12. The method of claim 1, wherein at least one of the first and second communication devices is communicatively linked to a management server; wherein sending the directive comprises:
the first communication device sending a request to the management server;
responsive to the request, the management server:
sends the directive containing a command to the second communication device, or
obtains content for delivery to the second communication device.

13. A system for improved interaction between communication devices comprising:
a first communication device;
a second communication device, the first and second communication devices being communicatively linked; and
the first communication device being configured to:
receive a user input selecting a content source identifier specifying a content source or a content file with an associated content type descriptor;
compare the content type descriptor to a pre-identified set of one or more content type descriptors; and
send a directive containing a command to the second communication device if the content type descriptor is included in the pre-identified set of content type descriptors;
the second communication device being configured to initiate an action specified by the command received from the first communication device.

14. The system of claim 13, wherein at least one of the first and second communication devices is a portable communication device.

15. The system of claim 13, wherein the second communication device is adapted to only receive directives from the first communication device, whereby the second communication device does not transmit directives to the first communication device.

16. The system of claim 13, wherein the content type descriptor is a MIME type.

17. The system of claim 13, wherein the content source is a web page, HTTP server, FTP server, or HTTP server that does not present websites.

18. The system of claim 13, wherein the content source identifier is a Uniform Resource Locator, Uniform Resource Identifier, Uniform Resource Name, Internationalized Resource Identifier, Digital Object Identifier or a content file attached to a message.

19. The system of claim 13, further including a management server, wherein at least one of the first and second communication devices are communicatively linked to the management server.

20. A first communication device, comprising:
a processor; and
a transceiver;
wherein the transceiver is configured to receive a user input selecting a content source identifier specifying a content source or a content file with an associated content type descriptor;
wherein the processor is operable to compare the content type descriptor to a pre-identified set of one or more content type descriptors; and
send a directive containing a command to a second communication device if the content type descriptor is included in the pre-identified set of content type descriptors, whereby the second communication device initiates an action specified by the command received from the first communication device.
